(19) United States
(12) Patent Application Publication
(10) Pub. No.: US 2017/0009319 A1
(43) Pub. Date: Jan. 12, 2017

(54) ENERGY EFFICIENT SALT-FREE RECOVERY OF METAL FROM DROSS

(71) Applicant: Pyrogenesis Canada Inc., Montreal (CA)

(72) Inventors: Michel G. Drouet, Montreal (CA); Francois Rivard, Montreal (CA); Pierre Carabin, Montreal (CA)

(21) Appl. No.: 15/094,857

(22) Filed: Apr. 8, 2016

Related U.S. Application Data
(63) Continuation of application No. 13/655,204, filed on Oct. 18, 2012, now abandoned.
(60) Provisional application No. 61/548,427, filed on Oct. 18, 2011.

(51) Int. Cl. C22B 21/00; C22B 7/04; C22B 9/05; F27D 3/16; F27B 7/10; F27B 7/16; F27B 7/20; C22B 21/06; F27B 7/06

(52) U.S. Cl. CPC C22B 21/0092; C22B 21/0069; C22B 21/064; C22B 7/04; C22B 9/055; F27B 7/06; F27B 7/10; F27B 7/16; F27B 7/2016; F27D 3/16; F27D 2003/163; F27D 2003/167

(57) ABSTRACT

A process and an apparatus are disclosed for improved recovery of metal from hot and cold dross, wherein a dross-treating furnace is provided with a filling material with good capacity to store heat. This filling material is preheated to a desired temperature by injection of an oxidizing gas to burn non-recoverable metal remaining in the filling material after tapping of the recoverable metal contained in the dross and discharging of the treatment residue. When dross is treated in such furnace, the heat emanating by conduction from the filling material is sufficient to melt and separate the recoverable metal contained in the dross, without addition of an external heat source, such as fuel or gas burners, plasma torches or electric arcs and without use of any salt fluxes. Furthermore, the recovered metal being in the molten state can be fed to the molten metal holding furnace without cooling the melt; in addition, the non-use of fluxing salt for the treatment means that the non-contaminated residue can be used as a cover for the electrolytic cells in the case of aluminum. In the case of zinc dross, the residue is a valuable zinc oxide by-product very low in contaminants.

### CROSS REFERENCE TO RELATED APPLICATIONS

This Application claims priority on U.S. Provisional Application No. 61/548,427, now pending, filed on Oct. 18, 2011, which is herein incorporated by reference.

### FIELD OF THE INVENTION

The present invention relates to the salt-free recovery of non-ferrous metals, such as aluminum, from dross, without the use of any external heat source.

### BACKGROUND OF THE INVENTION

Dross is a material which forms on the surface of molten non-ferrous metals, such as aluminum or zinc, during remelting, metal holding and handling operations when the molten metal is in contact with a reactive atmosphere. Dross normally consists of metal oxides entraining a considerable quantity of molten free (unreacted) metal, and for economic reasons it is desirable to extract the free metal before discarding the residue. Recovery can be carried out by treating the dross in a furnace at a high temperature. For this purpose, several furnaces have been devised and are presently being used; such furnaces are normally heated with an external heat source, such as fuel- or gas-operated burners, plasma torches, or electric arcs.

In aluminum processing-operations, for example, the dross, which normally contains about 50% aluminum metal, is skimmed off from the surface of the molten metal in a smelting or similar furnace and is usually loaded into special containers or pans where it is cooled and then it is stored, before being processed in a dross treating furnace which, as mentioned above, is heated with an external heat source.

The use of fuel- or gas-operated burners for heating the dross in a dross treating furnace, in order to recover the aluminum contained therein, has the major drawback of requiring the addition of salt fluxes such as NaCl or KCl, used to increase the percentage of aluminum recovery. Apart from the fact that such salt fluxes increase the cost of the operation, they also lead to increased pollution and are, therefore, environmentally undesirable.

The use of a plasma torch as, for instance, disclosed in U.S. Pat. No. 4,952,237 issued on Aug. 28, 1990, or of an electric arc as disclosed in U.S. Pat. No. 5,245,627 issued on Sep. 14, 1993 permits the above-mentioned drawback to be overcome. Indeed, the use of plasma or arcs creates higher temperatures in the furnace and thus avoids the necessity of adding salt fluxes. However, both technologies use electricity which in many cases may be more expensive than using fuel or gas heating. Furthermore, the use of plasma or arcs requires a significant capital investment in power supplies, controllers and other related equipment.

As mentioned in U.S. Pat. No. 4,952,237, it has also been proposed to extract the liquid metal from dross by mechanical compression of the hot dross removed directly from a furnace. Such a process requires expensive equipment and high dross temperatures and is limited by these factors to relatively large scale operations. Moreover, such approach does not directly address the disposal problems because the residue will still contain a large quantity of free metal.

It has also been proposed in the case of aluminum dross to induce and maintain burning or thermitting of the dross under controlled conditions by working the dross in an inclined rotary barrel open to the atmosphere or subjected to oxygen injection as disclosed, for example, in U.S. Pat. No. 5,447,548, issued on Sep. 5, 1995. This permits a certain portion of the metal content to be consumed in order to recover the remainder. This method has the drawback of resulting in poorer metal recovery as some of the metal is burned to provide the heat required for the process.

In U.S. Pat. No. 5,308,375 issued on May 3, 1994, the furnace heating by a plasma torch is followed by oxygen injection prior to metal tapping. This results in a direct heating of the charge during the separation process which, according to this patent, results in a significant reduction of the plasma power time and of the total cycle time. However, such procedure will undoubtedly result in combustion of some of the recoverable metal separated from the dross.

In Canadian Patent Application No. 2,116,249, which was laid-open to public inspection on Aug. 24, 1995, a gas or fuel burner is used to heat the charge. When the charge reaches a certain temperature, an oxidizing agent such as oxygen is injected onto the charge in the belief that only the unrecoverable finest aluminum particles would be combusted in providing heat for the process. This opinion is shared by U.S. Pat. No. 5,308,375 mentioned above. In both of these processes, oxygen is injected prior to metal tapping in the belief that the recoverable metal would not react with the oxygen and therefore the metal recovery rate would not be affected. No data is presented to support this contention. However, comparative tests conducted at the Hydro-Quebec Research Laboratory on several hundred tons of aluminum drosses have shown that dross treatment in an inert atmosphere such as argon produced a metal recovery rate higher by as much as 7% than the treatment conducted in open air; this data (published in “Proceedings of the International Symposium on Environmental Technologies: Plasma Systems and Applications”, Volume II, Oct. 8-11, 1995, Atlanta, Ga., U.S.A., p. 546) indicates that the recovery rate is likely to be affected by injection of an oxidizing agent onto the charge itself, before tapping the metal.

In U.S. Pat. No. 6,159, 269 issued on Dec. 12, 2000, a process and an apparatus are disclosed for the recovery of metal from hot dross wherein the furnace wall is preheated by burning some non-recoverable metal remaining in the dross residue after metal tapping. The heat stored in this way in the furnace wall was thought to be sufficient to heat the next batch of hot dross without any addition of external heat source such as fuel or gas burners, plasma torches or electric arcs.

According to data published in Light Metals Warrendale—Proceedings 2004, Year 2004 Pages 931-936, that process was demonstrated successfully in several aluminum plants using a small pilot unit able to treat up to 78 kg of aluminum dross.

It is believed that the process was also successful in the recovery of metal from zinc dross.

However, that process, well proven on a very small scale with hot drosses cannot be scaled up for industrial scale operation of a furnace for the treatment of dross, and more particularly the treatment of cold dross. For example, the energy required to heat a batch of 10 tons of aluminum dross containing 50% free metal from a room temperature to a temperature of 700° C. is more than 10 000 megajoules. By contrast, a furnace properly sized to treat such a 10-ton batch of dross would have only enough refractory surfaces to store at most 1 megajoule of energy. The problem, which arises with the scale-up of the process according to U.S. Pat. No. 6,159, 269, comes from the fact that although the volume of dross that a given furnace can accommodate increases with the cube of its dimension, its capacity to store energy increases only as the square of that dimension.

An additional drawback with U.S. Pat. No. 6,159, 269, is that it requires that the dross residue be discharged at a very high temperature, possibly 1200° C., certainly well above the stated required furnace refractory temperature of 1000° C.; such is both an important waste of energy and a very dangerous operation with a high risk of intense combustion of the residue as it is discharged from the furnace and comes in contact with air.

In the case of zinc dross, the dross, once cold, is crushed in a ball mill followed by separation of the metallic particles from the oxide powder by sieving. That process leads to a very poor metal recovery and, in addition, an important amount of the separated metal is lost when dumped into the holding furnace as it oxidizes on the surface of the melt.

In the case of aluminum dross, the reintroduction of the recovered metal also negatively affects the control of the holding furnace. In that case, it is large metal ingots which are fed into the holding furnace; the ingots, being cold, negatively affect the temperature control of the holding furnace.

Therefore, there is a need in the art for an improved technology for recovering non-ferrous metals, such as aluminum and zinc, from dross, in a salt-free manner and without the use of external heat sources.

There is also a need to provide a new technology allowing for the reintroduction of the recovered metal into the holding furnace, avoiding loss of metal and negative effects on the operation of the holding furnace.

### SUMMARY OF THE INVENTION

It is therefore an aim of the present invention to provide a novel process and apparatus for recovering non-ferrous metals from drosses containing the same.

Therefore, in accordance with the present invention, there is provided a process for treating dross containing a recoverable metal, in order to recover said metal, comprising:

(a) charging a batch of dross, resulting from skimming of said dross in a metallurgical plant, into a furnace containing a filling material preheated to a high enough temperature to insure that said dross is thereby heated above the melting point of the metal to be recovered by transfer of energy stored in the filling material;

(b) providing an inert atmosphere in the furnace by filling the furnace with inert gas, to prevent oxidation of the dross during the process;

(c) rotating or oscillating the dross within the furnace to ensure proper transfer of heat between the hot filling material and the dross and heating of the dross to a temperature above the melting point of the recoverable metal, its separation from the dross residue and from the filling material and its agglomeration at the bottom of the furnace;

(d) removing from the furnace the recoverable free metal through a taphole or through the door and the dross residue through the door while leaving inside the furnace the filling material and a fraction of non-recoverable metal which stays with said filling material as it cannot be separated from it;

(e) thereafter, injecting a controlled amount of an oxidizing gas into the furnace while rotating or oscillating the furnace, so as to oxidize sufficient non-recoverable metal within the filling material to evenly heat and store in the filling material sufficient energy for treating a new batch of dross resulting from a further skimming of the dross in the metallurgical plant;

(f) thereafter, stopping the oxidation reaction by providing an inert atmosphere in the furnace by filling the furnace with inert gas; and

(g) charging into the furnace the new batch of dross and repeating the process.

Also in accordance with the present invention, there is provided an apparatus for recovering metal, such as aluminum, contained in a dross, comprising:

(a) a rotary or oscillatory furnace adapted for high temperature treatment of drosses, said furnace having a chamber partially filled with a filling material capable of accumulating and conducting heat provided by an exothermic reaction within said chamber, said filling material also being capable of storing a high density of heat suitable for heating a charge of dross above the melting point of the metal to be recovered, said furnace also having an opening through which dross may be charged into the chamber and dross residue discharged from said chamber, as well as a door for hermetically closing said opening during treatment of the dross, and said furnace further having a tap hole for tapping recovered molten metal:

(b) means for rotating or oscillating said furnace;

(c) means for injecting an inert gas into said furnace;

(d) means for controllably injecting an oxidizing gas into said furnace;

(e) means for monitoring the temperature of the dross charge inside the furnace and of the filling material remaining in the furnace after tapping the recovered molten metal and discharging the dross residue;

(f) means for returning the recovered metal in the molten state to the holding furnace; and

(g) means for pouring the recovered molten metal into the holding furnace.

Further in accordance with the present invention, there is provided a process for treating dross containing a recoverable metal, in order to recover said metal, comprising the steps:

(a) charging a batch of dross into a furnace containing a filling material preheated to a high enough temperature to insure that said dross is thereby heated above the melting point of the metal to be recovered;

(b) providing an inert atmosphere in the furnace to prevent oxidation of the dross during the process;

(c) rotating or oscillating the dross within the furnace to ensure proper transfer of heat between the hot filling material and the dross and heating of the dross to a temperature above the melting point of the recoverable metal, its separation from the dross residue and from the filling material and its agglomeration at the bottom of the furnace;

(d) removing from the furnace the recoverable free metal in a molten state;

(e) transferring the recovered molten metal to the holding furnace for pouring in the melt;

(f) removing the dross residue while leaving inside the furnace the filling material and a fraction of non-recoverable metal;

(g) injecting a controlled amount of an oxidizing gas into the furnace while rotating or oscillating the furnace, so as to oxidize sufficient non-recoverable metal within the filling material to evenly heat and store in the filling material sufficient energy for treating a new batch of dross;

(h) stopping the oxidation reaction by providing an inert atmosphere in the furnace by filling the furnace with inert gas; and

(i) charging into the furnace the new batch of dross and repeating the process.

Still further in accordance with the present invention, there is provided an apparatus for recovering metal, such as aluminum, contained in a dross, comprising:

(a) a rotary or oscillatory furnace adapted for high temperature treatment of drosses, said furnace having a chamber adapted to be partially filled with a filling material capable of accumulating and conducting heat provided by an exothermic reaction within said chamber, said filling material also being capable of storing a high density of heat suitable for heating a charge of dross above the melting point of the metal to be recovered, said furnace also having an opening through which dross may be charged into the chamber and dross residue discharged from said chamber, as well as a door for closing said opening during treatment of the dross, and said furnace further having a tap hole for tapping recovered molten metal:

(b) a moving device for rotating or oscillating said furnace;

(c) a first injection device for injecting an inert gas into said furnace;

(d) a second injection device for controllably injecting an oxidizing gas into said furnace;

(e) a monitoring system for monitoring the temperature of the dross charge inside the furnace and of the filling material remaining in the furnace after tapping the recovered molten metal and discharging the dross residue; and

(f) a suitable container such as an insulating refractory lined ladle for transporting the recovered molten metal and for pouring it into the plant molten metal holding furnace.

Still further in accordance with the present invention, there is provided a process for treating dross containing a recoverable metal, in order to recover said metal, comprising:

(a) charging a batch of dross into a furnace containing a filling material preheated to a sufficient temperature to insure that said dross is thereby heated above the melting point of the metal to be recovered by transfer of energy stored in the filling material;

(b) providing an inert atmosphere in the furnace by filling the furnace with inert gas, to prevent oxidation of the dross during the process;

(c) rotating or oscillating the dross within the furnace to ensure proper transfer of heat between the filling material and the dross and heating of the dross to a temperature above the melting point of the recoverable metal, a separation thereof from the dross residue and from the filling material and agglomeration thereof at the bottom of the furnace;

(d) removing from the furnace the recoverable free metal while leaving inside the furnace the filling material and a fraction of non-recoverable metal.

Still further in accordance with the present invention, there is provided an apparatus for recovering metal, such as aluminum, contained in a dross, comprising:

(a) a rotary or oscillatory furnace adapted for high temperature treatment of drosses, said furnace having a chamber partially filled with a filling material capable of accumulating and conducting heat provided by an exothermic reaction within said chamber, said filling material also being capable of storing heat suitable for heating a charge of dross above the melting point of the metal to be recovered, said furnace also having an opening through which dross may be charged into the chamber and dross residue discharged from said chamber, as well as a door for hermetically closing said opening during treatment of the dross, and said furnace further having a tap hole for tapping recovered molten metal:

(b) an inert gas injection device for injecting an inert gas into said furnace;

(c) an oxidizing gas for controllably injecting an oxidizing gas into said furnace;

(d) a monitoring device for monitoring the temperature of the dross charge inside the furnace and of the filling material remaining in the furnace after tapping of the recovered molten metal and discharging of the dross residue; and

(e) a conveying device for returning the recovered metal in the molten state to the holding furnace.

Still further in accordance with the present invention, there is provided a process for treating dross containing a recoverable metal, in order to recover said metal, comprising the steps:

(a) charging a batch of dross into a furnace containing a filling material preheated to a high enough temperature to insure that said dross is thereby heated above the melting point of the metal to be recovered;

(b) providing an inert atmosphere in the furnace to prevent oxidation of the dross during the process;

(c) rotating or oscillating the dross within the furnace to ensure proper transfer of heat between the hot filling material and the dross and heating of the dross to a temperature above the melting point of the recoverable metal, a separation thereof from the dross residue and from the filling material and agglomeration thereof at the bottom of the furnace;

(d) removing from the furnace the recoverable free metal in a molten state;

(e) transferring the recovered molten metal to the holding furnace for pouring in the melt;

(f) removing the dross residue while leaving inside the furnace the filling material and a fraction of non-recoverable metal;

(g) injecting a controlled amount of an oxidizing gas into the furnace while rotating or oscillating the furnace, so as to oxidize sufficient non-recoverable metal within the filling material to evenly heat and store in the filling material sufficient energy for treating a new batch of dross;

(h) stopping the oxidation reaction by providing an inert atmosphere in the furnace by filling the furnace with inert gas; and

(i) charging into the furnace the new batch of dross and repeating the process.

Still further in accordance with the present invention, there is provided an apparatus for recovering metal, such as aluminum, contained in a dross, comprising:

(a) a rotary or oscillatory furnace adapted for high temperature treatment of drosses, said furnace having a chamber adapted to be partially filled with a filling material capable of accumulating and conducting heat provided by an exothermic reaction within said chamber, said filling material also being capable of storing heat suitable for heating a charge of dross above the melting point of the metal to be recovered, said furnace also having an opening through which dross may be charged into the chamber and dross residue discharged from said chamber, as well as a door for closing said opening during treatment of the dross, and said furnace further having a tap hole for tapping recovered molten metal:

(b) a moving device for rotating or oscillating said furnace;

(c) a first injection device for injecting an inert gas into said furnace;

(d) a second injection device for controllably injecting an oxidizing gas into said furnace;

(e) a monitoring system for monitoring the temperature of the dross charge inside the furnace and of the filling material remaining in the furnace after tapping the recovered molten metal and discharging the dross residue; and

(f) a suitable container such as an insulating refractory lined ladle for transporting the recovered molten metal and for pouring it into the plant molten metal holding furnace.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

Reference will now be made to the accompanying drawings, showing by way of illustration an illustrative embodiment of the present invention, and in which:

FIG. 1 is a side elevation view of a rotary furnace in accordance with the present invention, and shown in a run/tapping mode thereof;

FIG. 2 is a front elevation view of the furnace in the run/tapping mode;

FIG. 3 is a side elevation view of the furnace in an emptying mode thereof; and

FIG. 4 is a front elevation view of the furnace in the emptying mode.

### DESCRIPTION OF ILLUSTRATIVE EMBODIMENTS OF THE INVENTION

Scale-up to industrial operation will have to be possible, safety issue requiring discharging of both the metal and the residue at low temperatures will be addressed as well as issues of protection of the environment, non-discharge of greenhouse gas and great attention to energy savings.

Furthermore, recovery of the metal will be achieved without any use of salt fluxes and with a significantly reduced off-gas generation requiring smaller gas cleaning equipment.

Reintroduction of the recovered metal into the holding furnace will be made in such a way as to avoid (i) oxidation of metal, (ii) perturbation of the holding furnace operation and (iii) the loss of heat.

In essence, the present process for treating dross containing a recoverable metal, such as aluminum, in order to recover this metal, comprises the following steps, which are also represented in the illustration below:

(a) charging a new batch of dross into a refractory-lined furnace containing a sufficient amount of a filling material, such as dross residue produced in the treatment of previous batches of dross, previously heated in the furnace, under an inert atmosphere, to a high enough temperature to insure that this new batch of dross is thereby heated above the melting point of the metal to be recovered by transfer of energy stored in the filling material;

(b) rotating or oscillating the dross within the furnace to insure (i) proper heating of the dross to a temperature above the melting point of the metal to be recovered, (ii) separation of that metal from both the dross residue and from the filling material and finally, (iii) accumulation of the recoverable free metal at the bottom of the furnace;

(c) removing from the furnace, at low temperature, both the recoverable free molten metal and

(d) the dross residue while leaving inside the furnace the filling material and a fraction of non-recoverable metal which stays within this filling material as it cannot be recovered;

(e) thereafter, injecting a controlled amount of an oxidizing gas, such as oxygen, into the furnace while rotating or oscillating the furnace, so as to oxidize sufficient non-recoverable metal within the filling material and through resulting exothermic oxidation reaction to evenly transfer to the filling material sufficient energy to heat the filling material to a temperature suitable for treating a new batch of dross and therefore repeating the process. The oxidizing gas can be injected through a super alloy or ceramic tube protruding through the refractory shell or furnace door.

It should be mentioned that, before the very first charge, a small amount of the filling material, placed in the furnace, is ignited with an external heat source; once that small amount is burning, oxidizing gas is injected and the combustion propagates rapidly to the rest of the filling material leading to its complete heating at the temperature required to treat the first batch of dross, with all subsequent overheating of the filling material being done, without any external source, but simply through the oxidation reaction with oxidizing gas injection. The controlled amount of oxidizing gas injected to carry out the exothermic oxidation reaction is normally introduced into the reactor at a controlled rate to heat the filling material at a predetermined rate and to a predetermined temperature. The thermitting rate is controlled by monitoring the temperature and adjusting the oxidizing gas flow rate. Any runaway reaction is prevented by completely stopping the oxidizing gas injection and initiating inert gas injection.

The novel process may be carried out in a closable rotary refractory lined furnace, the rotation frequency of the furnace being adjusted to promote tumbling of the charge in the furnace barrel in order to maximize mixing of the cold dross charge with the hot filling material. The rotation may be carried out in a continuous or intermittent manner. It should be noted that U.S. Pat. No. 4,952,237 also considers the injection of oxygen into a dross treatment furnace after discharge of the metal. However, the objective of such operation is not to provide processing energy as is the present case and it is, therefore, totally different. Furthermore, the energy produced by the process disclosed in U.S. Pat. No. 4,952,237 is not sufficient to treat the cold dross being treated by that process.

In the present process, the complete processing of the dross is carried out under inert atmosphere in order to prevent oxidation of the recoverable metal; the injection of oxidizing gas to induce exothermic reaction in the filling material is only allowed once the tapping of the recoverable metal has been achieved and part of the dross residue has been discharged. However, in some exceptional circumstances it is also possible to inject a controlled amount of oxidizing gas into the furnace just prior to removing the recoverable free metal in order to provide a controlled oxidation of some free metal and thereby increase the temperature in the furnace if and when required.

It is also preferable to maintain a slight overpressure of inert gas, such as argon, during the steps (a), (b), (c) and (d) described hereinabove, to prevent any air inflow into the furnace chamber which otherwise would oxidize some of the metal during the steps of charging, processing or discharging from the furnace.

Follow hereinbelow illustrations of the process successive steps:

Now referring to the appended figures, the present process and apparatus will be further described, wherein the same reference numbers are used to describe the same parts.

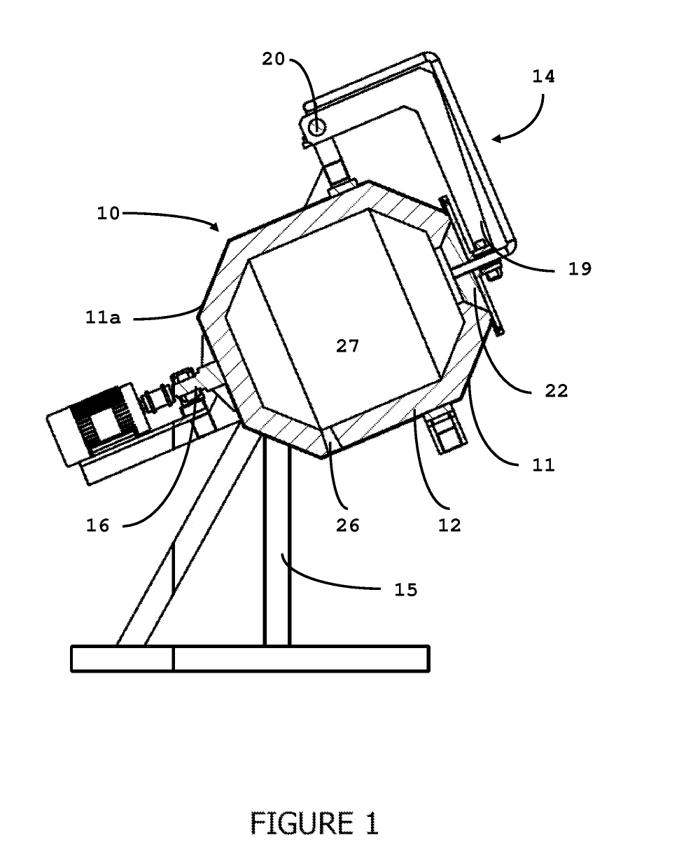

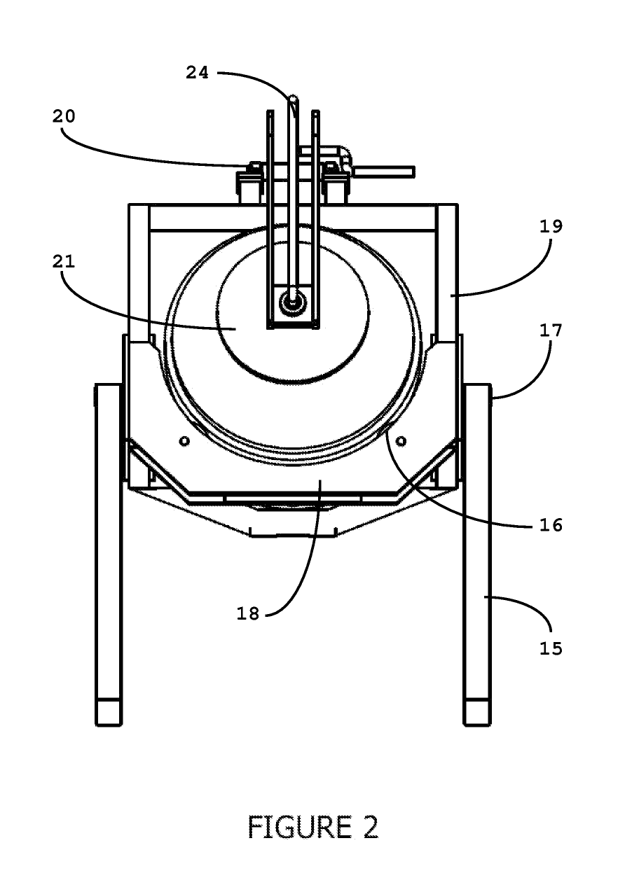

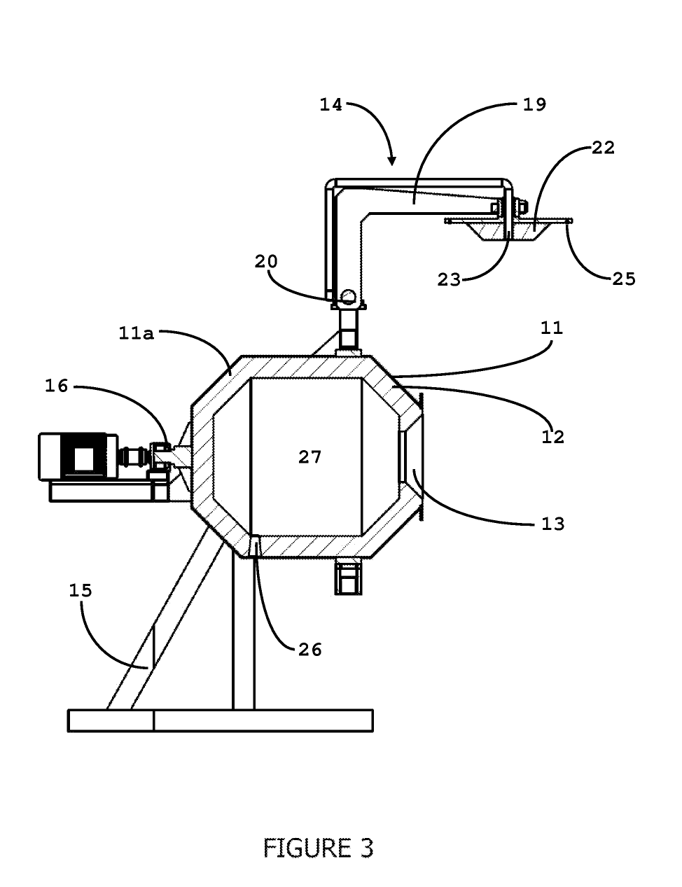

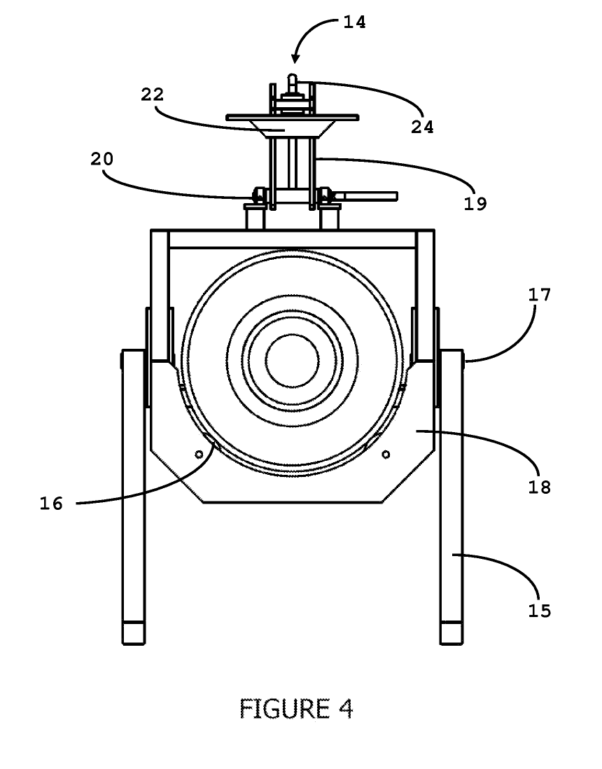

A furnace 10 suitable for the purposes of the present application is shown in the run/tapping mode in FIGS. 1 and 2 and similarly in the emptying mode in FIGS. 3 and 4. To show the positioning of the furnace 10 more clearly, a framework 15 in FIGS. 1 and 3 is drawn. The furnace 10 comprises a hollow steel cylinder 11 having its interior lined with a high temperature resistant refractory wall 12. As wall 12, one may use a high alumina castable refractory, for example.

One end of the cylinder 11 is closed by an end wall 11a while the other end has an opening 13 (see FIG. 3) which is closable by a door mechanism shown generally as 14. The above structure forms an enclosed furnace chamber 27 for treatment of dross when the door mechanism 14 closes the opening 13.

The cylinder 11 is rotatable and tiltable, supported by the framework 15. The framework 15 allows the cylinder 11 to rotate on its longitudinal axis on rollers and trunnions 16 or a gear ring rigidly connected to the cylinder 11 and a chain which passes around the gear ring. The rotation is driven by a motor capable of rotating the cylinder 11 either intermittently or continuously in either direction at speeds of up to 20 R.P.M. The arrangement of the rotating system is conventional and is not shown in the drawings. The framework 15 also permits the cylinder 11 to tilt about pivot 17. Tilting may be affected by a hydraulic piston which moves a cradle 18 within the framework 15.

The door mechanism 14 is supported by a framework 19 which can be tilted about pivots 20 with respect to the main framework 15. The door mechanism comprises a door mount 21 used to support a circular refractory lined door 22 so that the door can sit properly in the opening 13 of the cylinder 11 when the furnace 10 is in the run mode. The door 22 has a hole 23 which acts as a gas vent to permit escape of furnace gases to the exterior. The vent is covered by an exhaust conduit 24 enclosed within the door mount 21. Controlled amount of inert gas, such as argon, or oxidizing gas, such as oxygen, may be injected in the furnace using piping (not shown) mounted in the wall of the exhaust conduit 24 (see FIGS. 2 and 4) and a nozzle (not shown) located in the hole 23 of the door 22.

When the furnace 10 is in the run mode, the refractory-lined door 22 can be lowered and allowed to sit on the cylinder 11. In the run mode, the refractory-lined door 22 rotates with the cylinder 11. Escape of gases between the periphery of the opening 13 and the door 22 is prevented by a gasket 25 made of compressible material capable of withstanding high temperatures, like ceramic fiber rope. In the run mode, the door 22 is normally held closed simply by the pressure due to its own weight; however, a latch (not shown) may also be provided to further compress the gasket 25.

The apparatus described above is operated in the following manner:

The filling material content of the furnace 10 in the run position as illustrated in FIG. 1 has been preheated as a result of the exothermic oxidation of the non-recoverable metal remaining in the filling material of the previous batch. This is done by injection of an oxidizing gas, such as oxygen, at a controlled rate into the inert gas filled furnace 10 until a desired temperature is reached. The door 22 is seated on the cylinder 11 to prevent the energy stored in the filling material to escape to the exterior. As already mentioned previously, when initially starting the furnace 10, the filling material may be preheated using, for example, a gas burner, a plasma torch or an electric arc. A hot dross charge is prepared in a charging device (not shown) adapted to allow charging of the furnace chamber 27 when the cylinder 11 is tilted upwardly as shown in FIGS. 1 and 2. Then, the door 22 is opened and the charge of hot dross is dropped into the inert gas filled furnace chamber 27; in order to avoid damaging the refractory wall or lining 12 it may be desirable to tilt the furnace 10 horizontally as shown in FIGS. 3 and 4, in order to allow the charge to be pushed inside the furnace chamber 27 using a tool similar to an ember rake instead of being dropped in. The total dross charge, including the filling material, is such that it occupies about one quarter to one third of the total interior volume of the furnace chamber 27. The furnace cylinder 11, being in the run mode position (tilted upwardly), the door 22 is lowered to close tightly, compressing the gasket 25. The tilting angle of the cylinder 11 is such that maximum use is made of the volume of the furnace chamber 27 without affecting the tumbling effect of the charge which is normally needed for maximum recovery of metal contained in the dross by mixing and heat transfer with the overheated filling material followed by agglomeration of the metal droplets contained in the dross.

The cylinder 11 of the furnace 10 is then either rotated or preferably oscillated in the case when large blocks of dross were charged, low amplitude oscillation being preferred in that case to prevent damage to the refractory lining 12 which could result from the tumbling of the heavy dross blocks within the furnace 10. The tumbling noise produced by the large blocks of dross may be monitored using a sound monitor mounted in the gas exhaust conduit 24 and full rotation of the furnace would only be allowed to proceed once the tumbling noise signal is below a predetermined level. As the furnace is rotated, heat transfer occurs between the dross charge and the filling material. The temperature of the dross charge is monitored using a thermocouple mounted in the gas exhaust conduit 24 and several thermocouples mounted inside the refractory wall 12. For example, radio frequency (RF) transmission thermocouples can be used on the rotating furnace. Once the charge has reached a predetermined temperature as monitored by the thermocouples, the separated molten metal is tapped off into a suitable crucible. Tapping is carried out through a taphole 26 located at the lowest point in the cylinder 11 of the furnace 10 when in the upward tilt position (FIG. 1). The taphole plug is lined with refractory material that is replaced after each tap. While tapping the furnace 10, the door 22 remains sealed and the atmosphere in the furnace 10 is an inert gas such as argon. If preferred, tapping could also be made through the door opening 13.

The tapped metal can then be kept molten in a suitable container such as a refractory lined ladle, returned to the molten metal holding furnace and is poured into the melt of that holding furnace, thus avoiding loss of heat, metal oxidation and cooling of the holding furnace melt as would have occurred if the recovered metal was left to cool down before being reintroduced in the plant production line.

After the metal has been tapped, it is desirable to rotate the furnace 10 again for a certain period of time because repeated tests have shown that the solid residue floating on the molten metal bath remain wetted with appreciable amount of metal; in one example, following a first tapping of aluminum, the furnace 10 was rotated for a further five minutes, allowing a second tapping of an amount of metal corresponding to more than 20% of the first tapping.

After the recoverable metal has been tapped, the taphole 26 is closed, in the case where tapping was made using a tap hole. The furnace door 22 is then lifted, the furnace cylinder 11 is tilted forward as shown in FIG. 3 and the residue is discharged while rotating the furnace 10, leaving a fraction of the residue inside the furnace 10 which will act as the filling material for the next batch. Once the right amount of residue has been discharged, the rotation is stopped, the furnace cylinder 11 is placed in the run position illustrated by FIG. 1, and the furnace door 22 is closed to prevent heat loss by radiation.

In the case of aluminum dross, the mostly aluminum oxide residue can be recycled as a cover for the aluminum electrolytic cell, as it is not contaminated by salt.

In the case of zinc dross, the mostly zinc oxide residue can be recycled as a cover for the zinc leaching step.

In the case of zinc dross, the high temperature treatment step acts as a means of volatilizing contaminants, such as chlorides, sulphur, ammonia, and volatile metals, such as thallium. The contaminants having been eliminated during the high temperature processing of the dross in the furnace, the residue is a fine powdery product consisting of mostly zinc oxide, which can be marketed, for example, as an activator for rubber vulcanization or as an additive or filler to plastics, ceramics, glass and cement.

Once the furnace door has been closed, a controlled amount of oxidizing gas is injected into chamber 27 of the inert gas filled furnace 10 through the nozzle located inside the hole 23 of the door 22. Controlled oxidation of the non-recoverable metal contained in the filling material is thereby produced; the temperature of the filling material is monitored using the thermocouples previously mentioned. The furnace is rotated while the metal contained in the filling material is reacting with the injected oxidizing gas in order to evenly transfer the energy produced in the reaction to the filling material. Once the predetermined amount of oxidizing gas has been injected, or if the temperature monitored by the thermocouples indicates a temperature value at or above a predetermined level, the injection of oxidizing gas is stopped and the furnace 10 remains filled with inert gas.

Preheating of the cold furnace 10 is carried out using a fuel or gas burner or plasma torch or electric arc mounted on a support installed in front of the furnace with the door 22 opened. When the required temperature is reached, the preheating is completed, the external heat source is removed and the operating cycle described above can be initiated.

Preheating of the cold furnace 10 can also be achieved by first charging a batch of hot dross into the chamber 27, followed by the injection of an oxidizing gas into the chamber 27. Controlled oxidation of the metal contained in the dross will occur, resulting in an increase in the temperature in furnace 10, which will be monitored using the thermocouples previously mentioned. The furnace is rotated while the exothermic reaction is occurring in order to evenly distribute the heat to the dross charge in the furnace 10. Once the predetermined amount of oxidizing gas has been injected, or once the temperature monitored by the thermocouples indicates a temperature value at or above a predetermined level, the injection of oxidizing gas is stopped and the furnace 10 remains filled with inert gas.

The present process is further illustrated by the following example:

### EXAMPLE

The hot aluminum dross formed at the surface of the molten aluminum bath of the molten aluminum holding furnace is skimmed into containers before being transferred to the dross house for treatment in a DROSRITE furnace. During the transfer, the dross, in contact with air, continues to oxidize and therefore its temperature does not decrease. In fact, measurements have shown that the temperature of the dross remains high for several hours because of the heat generated by this oxidation. To prevent oxidation during cooling, for example, Alcan is marketing a dross cooler where argon is injected in the dross container to prevent contact of the dross with ambient air (c.f. “The Alcan Process for Inert Gas Dross Cooling” in the Journal of Metals, February 1991, pp. 52-53). Cooling the dross under inert atmosphere, such as argon, is of interest as it prevents a loss of metal which could otherwise be recovered by a subsequent treatment; however the energy contained in the hot dross is lost during cooling in the Alcan cooling box.

On the contrary, with the process and apparatus proposed herein, the energy content of the hot dross is not lost as it is charged right away in a preheated furnace which also contained the amount of preheated filling material required to treat that dross charge. In our example, corresponding to an industrial situation, we consider a batch of 6 metric tons of such dross, with 50% free metal content, charged into an inert gas filled furnace such as above furnace 10, which already contains 10 metric tons of filling material heated to a temperature of 1000° C. The mean temperature of the dross charge is assumed to be 400° C., although measurements in industry have shown the temperature to be much higher, of the order of 600° C.

The objective is to transfer energy from the overheated filling material into the hot dross charge to bring the total furnace content to 700° C. Once that objective is reached, both the metal and a portion of the dross residue will be discharged at the “low” temperature of 700° C., leaving inside the furnace the 10 metric tons of residues/filling material required for the treatment of the next batch of hot dross. Then, a controlled amount of oxygen is injected into the furnace to bring the filling material back to the original temperature of 1000° C. by burning sufficient non-recoverable metal within the filling material to evenly heat and store in the filling material sufficient energy for treating the next batch of hot dross.

The following calculations show that, in the 10 tons filling material, the energy available for transfer from 1000° C. to 700° C. to the hot dross corresponds to the energy required by the 6 tons hot dross to be heated from 400° C. to 700° C.:

Energy available: 1,06 MJ/t ° C. (1000-700)×10 t=3 180 MJ

Energy required: 1,06 MJ/t ° C. (700-400)×6 t+50%×398 MJ/t×6 t=3 102 MJ

To the energy required for the process, 3 102 MJ, which is lost as it remains with the discharged metal and residue, must be added the energy lost to the outside by the furnace and estimated at about 1 200 MJ for a furnace of that capacity over the 3 hours of the treatment cycle, for a total of about 4 302 MJ.

That 4 302 MJ of energy, produced by a controlled oxidation of non-recoverable metal in the filling material requires the burning of the following amount of metal:

4 302 MJ/31,32 kg/MJ=137 kg of aluminum.

This amount of aluminum corresponds to: 137 kg/10 t=1.4% of residual metal in the filling material. This residual metal is part of the non-recoverable metal which remains in any of the various processes which are in operation for the recovery of metal from dross. Measurements have shown that the amount of such residual metal in the residue after treatment is higher than 5%.

Of the 4 302 MJ of energy produced by oxidation of part of the residual metal, 3 180 MJ is therefore used to bring the filling material from 700° C. to 1 000° C. The remainder is used to maintain the refractory inside surface at the same temperature as the filling material in spite of heat conduction through that same refractory; that energy is also lost as it is transferred to the outside through the furnace wall.

It should be mentioned that the above-described preferred embodiments are in no way limitative and various modifications obvious to those skilled in the art can be made without departing from the spirit and scope of the present invention.

Finally, although the present invention has been described hereinabove by way of embodiments thereof, it may be modified, without departing from the nature and teachings of the subject invention as described herein.

1. A process for treating dross containing a recoverable metal, in order to recover said metal, comprising:
(a) charging a batch of dross, resulting from skimming of said dross in a metallurgical plant, into a furnace containing a filling material preheated to a high enough temperature to insure that said dross is thereby heated above the melting point of the metal to be recovered by transfer of energy stored in the filling material;
(b) providing an inert atmosphere in the furnace by filling the furnace with inert gas, to prevent oxidation of the dross during the process;
(c) rotating or oscillating the dross within the furnace to ensure proper transfer of heat between the hot filling material and the dross and heating of the dross to a temperature above the melting point of the recoverable metal, a separation thereof from a dross residue and from the filling material and its agglomeration at the bottom of the furnace;
(d) removing from the furnace the recoverable free metal through a taphole or through the door and the dross residue through the door while leaving inside the furnace the filling material and a fraction of non-recoverable metal which stays with said filling material as it cannot be separated from it;
(e) thereafter, injecting a controlled amount of an oxidizing gas into the furnace while rotating or oscillating the furnace, so as to oxidize sufficient non-recoverable metal within the filling material to evenly heat and store in the filling material sufficient energy for treating a new batch of dross resulting from a further skimming of the dross in the metallurgical plant;
(f) thereafter, stopping the oxidation reaction by providing an inert atmosphere in the furnace by filling the furnace with inert gas; and
(g) charging into the furnace the new batch of dross and repeating the process.

2-4. (canceled)

5. A process according to claim 1, wherein the oxidizing gas is injected at a controlled rate.

6. A process according to claims claim 1, wherein the oxidizing gas is oxygen.

7. A process according to claims claim 1, wherein the oxidation reaction is stopped upon achieving satisfactory heating of the filling material by injecting an inert gas into the furnace.

8. A process according to claim 7, wherein the inert gas injected to stop the oxidation reaction in step (f) is argon.

9. A process according to claim 7, wherein the inert gas injected to stop the oxidation reaction in step (f) is replaced by nitrogen.

10-12. (canceled)

13. A process according to claim 1, wherein a small amount of the filling material is ignited with an external heat source, such as fuel or gas or oxy burners, plasma torches or electric arcs, only for starting the oxidation of the filling material leading to its complete heating at the temperature required to treat the next batch of dross, with all subsequent heating of the filling material being done through the oxidation reaction as described in step (e).

14-19. (canceled)

20. An apparatus for recovering metal, such as aluminum, contained in a dross, comprising:
(a) a rotary or oscillatory furnace adapted for high temperature treatment of drosses, said furnace having a chamber partially filled with a filling material capable of accumulating and conducting heat provided by an exothermic reaction within said chamber, said filling material also being capable of storing heat suitable for heating a charge of dross above the melting point of the metal to be recovered, said furnace also having an opening through which dross may be charged into the chamber and dross residue discharged from said chamber, as well as a door for hermetically closing said opening during treatment of the dross, and said furnace further having a tap hole for tapping recovered molten metal:
(b) means for rotating or oscillating said furnace;
(c) means for injecting an inert gas into said furnace;
(d) means for controllably injecting an oxidizing gas into said furnace;
(e) means for monitoring the temperature of the dross charge inside the furnace and of the filling material remaining in the furnace after tapping the recovered molten metal and discharging the dross residue;
(f) means for returning the recovered metal in the molten state to the holding furnace; and
(g) means for pouring the recovered molten metal into the holding furnace.

21-31. (canceled)

32. A process for treating dross containing a recoverable metal, in order to recover said metal, comprising:
(a) charging a batch of dross into a furnace containing a filling material preheated to a sufficient temperature to insure that said dross is thereby heated above the melting point of the metal to be recovered by transfer of energy stored in the filling material;
(b) providing an inert atmosphere in the furnace by filling the furnace with inert gas, to prevent oxidation of the dross during the process;
(c) rotating or oscillating the dross within the furnace to ensure proper transfer of heat between the filling material and the dross and heating of the dross to a temperature above the melting point of the recoverable metal, a separation thereof from a dross residue and from the filling material and agglomeration thereof at the bottom of the furnace;
(d) removing from the furnace at least some of the recoverable free metal while leaving inside the furnace the filling material and a fraction of non-recoverable metal.

33. A process according to claim 32, wherein the filling material is a dross residue produced in the treatment of previous batches of dross.

34. A process according to claim 32, wherein the inert gas is argon.

35. A process according to claim 32, wherein the inert gas is replaced with nitrogen.

36-40. (canceled)

41. A process according to claim 32, wherein there is provided a slight overpressure of inert gas to prevent any air inflow into the furnace.

42. A process according to claim 32, wherein a controlled amount of oxidizing gas is also injected into the furnace just prior to removing free metal so as to provide a controlled oxidation of some free metal and thereby increase the temperature of the metal in the furnace when required.

43. A process according to claim 32, wherein a batch of hot dross, charged into a cold empty furnace filled with an inert gas, is further heated by injection of an oxidizing gas into the furnace, while rotating and oscillating the furnace, so as to oxidize sufficient recoverable metal within the dross to evenly heat the dross above the temperature required for metal tapping.

44. (canceled)

45. A process according to claim 32, wherein the recoverable metal is one of aluminum, zinc, lead and nickel.

46. A process according to claim 32, wherein the filling material acts as a thick blanket which protects the furnace refractory wall from both mechanical and thermal shocks as the cold dross chunks are charged and tumble before crumbling.

47. A process according to claim 32 to treat aluminum dross, wherein the mostly aluminum oxide residue can be recycled as a cover for an aluminum electrolytic cell.

48. A process according to claim 32 to treat zinc dross, wherein the mostly zinc oxide residue can be recycled as a cover for the zinc leaching step.

49. A process according to claim 32 to treat zinc dross, wherein the process residue is a by-product consisting of mostly zinc oxide, contaminants having been eliminated during the high temperature processing of the dross in the furnace.

50. A process according to claim 32, wherein the recovered metal following tapping and kept molten in a suitable container such as a refractory lined ladle is returned to the molten metal holding furnace and is poured into the melt of that holding furnace.

51. An apparatus for recovering metal, such as aluminum, contained in a dross, comprising:
(a) a rotary or oscillatory furnace adapted for high temperature treatment of drosses, said furnace having a chamber partially filled with a filling material capable of accumulating and conducting heat provided by an exothermic reaction within said chamber, said filling material also being capable of storing heat suitable for heating a charge of dross above the melting point of the metal to be recovered, said furnace also having an opening through which dross may be charged into the chamber and dross residue discharged from said chamber, as well as a door for hermetically closing said opening during treatment of the dross, and said furnace further having a tap hole for tapping recovered molten metal:
(b) an inert gas injection device for injecting an inert gas into said furnace;
(c) an oxidizing gas for controllably injecting an oxidizing gas into said furnace;
(d) a monitoring device for monitoring the temperature of the dross charge inside the furnace and of the filling material remaining in the furnace after tapping of the recovered molten metal and discharging of the dross residue; and
(e) a conveying device for returning the recovered metal in the molten state to the holding furnace.

52. The apparatus according to claim 51, wherein the furnace is also tiltable to facilitate charging and discharging of materials.

53-54. (canceled)

55. The apparatus according to claim 51, wherein the filling material is a dross residue produced in the treatment of previous batches of dross.

56. The apparatus according to claim 51, wherein the means for igniting a small amount of the filling material for starting the oxidation of the filling material, is a fuel, gas or oxy burner and/or an electric arc and/or a plasma torch.

57-58. (canceled)

59. The apparatus according to claim 51, wherein the process residue, in the case of the treatment of aluminum dross, is adapted to be used as a cover for an electrolytic cell.

60. (canceled)

61. A process for treating dross containing a recoverable metal, in order to recover said metal, comprising the steps:
(a) charging a batch of dross into a furnace containing a filling material preheated to a high enough temperature to insure that said dross is thereby heated above the melting point of the metal to be recovered;
(b) providing an inert atmosphere in the furnace to prevent oxidation of the dross during the process;
(c) rotating or oscillating the dross within the furnace to ensure proper transfer of heat between the hot filling material and the dross and heating of the dross to a temperature above the melting point of the recoverable metal, a separation thereof from a dross residue and from the filling material and agglomeration thereof at the bottom of the furnace;
(d) removing from the furnace recoverable free metal in a molten state;
(e) transferring the recovered molten metal to the holding furnace for pouring in the melt;
(f) removing the dross residue while leaving inside the furnace the filling material and a fraction of non-recoverable metal;
(g) injecting a controlled amount of an oxidizing gas into the furnace while rotating or oscillating the furnace, so as to oxidize sufficient non-recoverable metal within the filling material to heat and store in the filling material sufficient energy for treating a new batch of dross;
(h) stopping the oxidation reaction by providing an inert atmosphere in the furnace by filling the furnace with inert gas; and
(i) charging into the furnace the new batch of dross and repeating the process.

62. An apparatus for recovering metal, such as aluminum, contained in a dross, comprising:
(a) a rotary or oscillatory furnace adapted for high temperature treatment of drosses, said furnace having a chamber adapted to be partially filled with a filling material capable of accumulating and conducting heat provided by an exothermic reaction within said chamber, said filling material also being capable of storing heat suitable for heating a charge of dross above the melting point of the metal to be recovered, said furnace also having an opening through which dross may be charged into the chamber and dross residue discharged from said chamber, as well as a door for closing said opening during treatment of the dross, and said furnace further having a tap hole for tapping recovered molten metal:
(b) a moving device for rotating or oscillating said furnace;
(c) a first injection device for injecting an inert gas into said furnace;
(d) a second injection device for controllably injecting an oxidizing gas into said furnace;
(e) a monitoring system for monitoring the temperature of the dross charge inside the furnace and of the filling material remaining in the furnace after tapping the recovered molten metal and discharging the dross residue; and
(f) a suitable container such as an insulating refractory lined ladle for transporting the recovered molten metal and for pouring it into the plant molten metal holding furnace.
